(19) United States
(12) Patent Application Publication
(10) Pub. No.: US 2012/0240535 A1
(43) Pub. Date: Sep. 27, 2012

(54) FILTER RETAINING APPARATUS

(75) Inventors: Richard Michael Ashley Mann, Basingstoke (GB); Abhijeet Madhukar Kulkarni, Basingstoke (GB)

(73) Assignee: General Electric Company

(21) Appl. No.: 13/053,643

(22) Filed: Mar. 22, 2011

(51) Int. Cl. B01D 46/42; B01D 50/00

(52) U.S. Cl. 55/385.7; 55/495

(57) ABSTRACT

Embodiments of the present invention secure a filter component to a filter system, via magnetism. Here, at least one magnet is attached to a structure of the filter system. Embodiments of the present invention include a filter connection apparatus for use in a filtering system that provides an ingested airstream to an inlet system. In particular, some embodiments of the present invention provide use a magnet to secure the filter to the filter system and gradually compress the filter against a sealing face of a filter frame. Furthermore, the magnet may comprise many forms, including permanent and non-permanent magnets.

### BACKGROUND OF THE INVENTION

The present invention relates generally to an apparatus for connecting a filter component to a filter system; and more particularly to an apparatus that incorporates a magnet or a magnetic clamping mechanism to secure the filter component to the filter system.

Power plant machines, such as, but not limiting of, gas turbines ingest a large amount of intake air (hereinafter “airstream”) to enable combustion. Gas turbines have an inlet system that channels the incoming airstream towards a compressor section. The inlet system usually has a filter section, which screens the airstream of foreign objects and other undesired particles; while helping to maintain suitable performance. The filter section typically comprises an array of filters arranged on a large filter frame. The filters are removable to enable cleaning and/or replacement. The filters are often held in place by the intake air pressure, which may, sufficiently press the filter against a filter receptacle to block the airstream from flowing around the filter.

In some applications however, the filter frame is tilted. Here, the air pressure may be insufficient at holding the filter in place. There are mechanical devices that assist with holding the filter in place. However, these devices often use substantial amounts of material, are cumbersome to use, and have loose parts that can be easily misplaced. Additionally, some of these devices may allow an operator to inadvertently over-tighten the mechanism, which could damage the filter or inhibit proper sealing.

For the foregoing reasons, there is a need for an improved apparatus for securing a filter to a filter frame. The system should be simple and cost effective. The apparatus should not use loose parts, and provide a consistent, controlled level of compression to the filter.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with an embodiment of the present invention, an apparatus for securing a filter to an inlet system component, the apparatus comprising: a filter cell comprising structure that houses a filter therein; wherein the filter cell substantially restrains movement of the filter; and a filter frame comprising a aperture of a size that allows the filter cell to reside therein, wherein the filter frame comprises a securing magnet or a magnetic clamping mechanism which secures the filter cell to the filter frame.

In accordance with an alternate embodiment of the present invention, a system for securing a filter to an inlet system component, the system comprising: a turbomachine comprising a compressor and a turbine section; an inlet system connected to the turbomachine upstream of the compressor; wherein the inlet system comprises: a weather hood; an inlet filter house; a transition piece; an inlet duct; and an inlet plenum; a filter cell comprising structure that houses a filter therein; wherein the filter cell substantially restrains movement of the filter; and a filter frame comprising a aperture of a size that allows the filter cell to reside therein, wherein the filter frame comprises a securing magnet which secures the filter cell to the filter frame.

### BRIEF DESCRIPTION OF THE DRAWINGS

These and other features, aspects, and advantages of the present invention may become better understood when the following detailed description is read with reference to the accompanying figures (FIGS) in which like characters represent like elements/parts throughout the FIGS.

FIG. 1 is a schematic illustrating a plan view of an environment where an embodiment of the present invention may operate.

FIG. 2 is a schematic illustrating an exploded perspective view of the filter frame of FIG. 1.

FIGS. 3A-3D, collectively FIG. 3, is a schematic illustrating isometric and detail views of an embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in an engineering or design project, numerous implementation-specific decisions are made to achieve the specific goals, such as compliance with system-related and/or business-related constraints, which may vary from one implementation to another. Moreover, it should be appreciated that such effort might be complex and time consuming, but would nevertheless be a routine undertaking of design, fabrication, and manufacture for those of ordinary skill having the benefit of this disclosure.

Detailed example embodiments are disclosed herein. However, specific structural and functional details disclosed herein are merely representative for purposes of describing example embodiments. Embodiments of the present invention may, however, be embodied in many alternate forms, and should not be construed as limited to only the embodiments set forth herein.

Accordingly, while example embodiments are capable of various modifications and alternative forms, embodiments thereof are illustrated by way of example in the figures and will herein be described in detail. It should be understood, however, that there is no intent to limit example embodiments to the particular forms disclosed, but to the contrary, example embodiments are to cover all modifications, equivalents, and alternatives falling within the scope of the present invention.

The terminology used herein is for describing particular embodiments only and is not intended to be limiting of example embodiments. As used herein, the singular forms “a”, “an” and “the” are intended to include the plural forms as well, unless the context clearly indicates otherwise. The terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Although the terms first, second, etc may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the FIGS. Indeed, the element or elements of an embodiment of the present invention may be oriented in any direction and the terminology, therefore, should be understood as encompassing such variations unless specified otherwise.

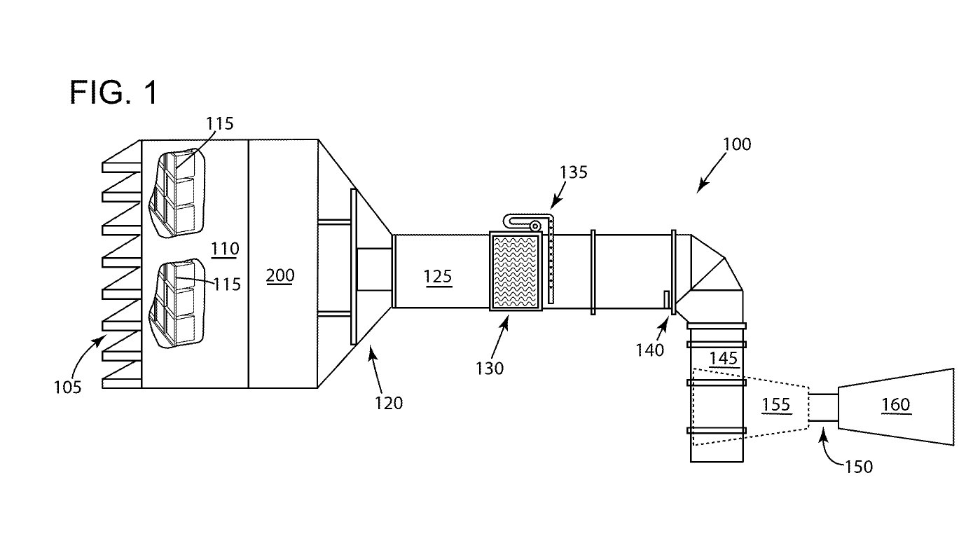

The present invention may be applied to a variety of inlet systems. This may include, but is not limiting to, those integrated with air-ingesting turbomachines. Although the following discussion relates to the inlet system illustrated in FIG. 1, embodiments of the present invention may be applied to an inlet system with a different configuration. For example, but not limiting of, the present invention may apply to an inlet system with different, or additional, components than those illustrated in FIG. 1.

Embodiments of the present invention use magnetism to secure a filter component to a filter system. Here, at least one magnet is attached to a structure of the filter system. Embodiments of the present invention include a filter connection apparatus for use in a filtering system that provides an ingested airstream to an inlet system. In particular, some embodiments of the present invention use a magnet to secure the filter to the filter system, and to gradually compress the filter against a sealing face of a filter holding frame. The magnet may comprise many forms, including permanent and non-permanent magnets.

Referring now to the FIGS, where the various numbers represent like elements throughout the several views, FIG. 1 is a schematic illustrating a plan view of an environment where an embodiment of the present invention may operate. FIG. 1 illustrates an inlet system 100 that may be integrated with a compressor 155 of a turbomachine 150. During operation of the turbomachine 150, the compressor 155 ingests an airstream that may derive from the ambient and flow through the inlet system 100.

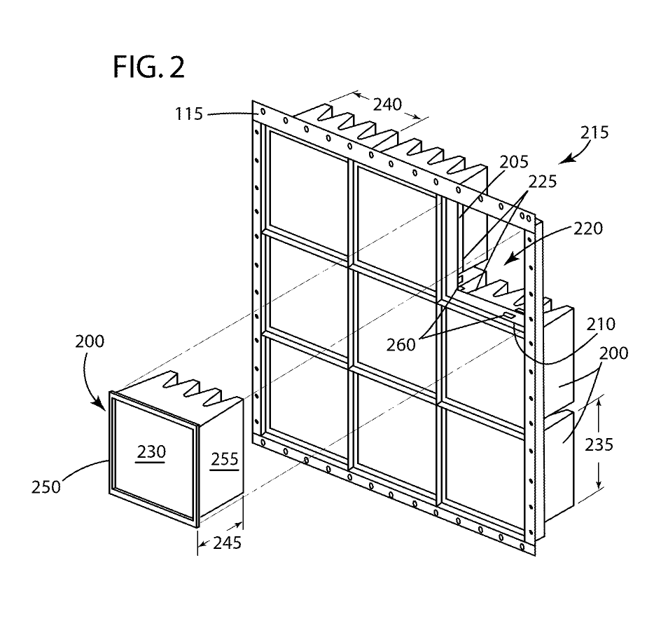

The following description provides an overview of a typical configuration of an inlet system 100. The present invention may be used with other configurations of the inlet system 100, which are not illustrated in the FIGS. The inlet system 100 channels the airstream ingested by the compressor 155. The airstream typically derives from the environment in which the turbomachine 150 operates. Initially, the airstream flows around a weather hood 105; which may prevent weather elements, such as rain, snow, etc, from entering the compressor 155. The airstream may then flow through an inlet filter house 110; which generally removes foreign objects, contaminants, and debris, such as, but not liming of: sand and other airborne particulate matter, from the airstream. The inlet filter house 110 comprises a filter frame 115 that secures an array of filters 200 (illustrated in FIG. 2). Next, the airstream may flow through a transition piece 120 and an inlet duct 125; these components may adjust the velocity and pressure of the airstream. Next, the airstream may flow through a silencer section 130. A typical inlet filter house 110 may be several stories high and may house several hundred filters 200 arranged on, and secured by, multiple filter frames 115.

Next, the airstream may flow through an inlet bleed heat system 135, which can increase the airstream temperature prior to entering the compressor 155. A screen 140, or the like, may be located downstream of the inlet duct 125 and generally serves to prevent debris from entering the compressor 155. The inlet plenum 145 may connect the inlet system 100 with the compressor 155.

FIG. 2 is a schematic illustrating an exploded perspective view of the filter frame 115 of FIG. 1. As illustrated in FIG. 2, the filter frame 115 may include a set of vertical support panels 205 and horizontal support panels 210 that define filter cells 215. The vertical support panels 205 and horizontal support panels 210 may serve as dividers between the filter cells 215; each of which may hold a single air filter 200. Each filter cell 215 may include an aperture 220 through which the filter 200 may pass, and a sealing face 225 against which the filter 200 may be pressed to prevent the airstream from flowing around the filter 200. The filter 200 may include a filter body 255 that passes through the aperture 220 and a sealing flange 250 disposed about the rim of the outward face 230 of the filter body 255. The sealing flange 250 may be configured to fit inside the filter cell 215 and may be pressed against the sealing face 225. A gasket may be disposed between the sealing face 225 and the filter flange 250, and to provide a substantially airtight seal between the filter 200 and the sealing face 225.

The filters 200 may be any suitable type, such as bag filters or mini-pleat or pulse filters, for example. In some embodiments, the filters 200 may be high-efficiency AltairSupernova™ filters, available from General Electric. Additionally, the filters 200 may also be any suitable size. For example, in some embodiments, the filter height 235 and width 240 may be approximate 600 mm, the filter depth 245 may be approximately 400 to 500 millimeters, and each filter may weight approximately 15 kilograms. The shape of the filters 200 may include, but is not limited to: cylindrical, or conical, or combinations thereof. Additionally, in some embodiments, the filter cells 215 and/or the filter frame 115 may be titled to provide allow condensed moisture to drain, which may collect on the outside of the filter 200.

Embodiments of the filter frame 115 may include several securing magnets 260, which may hold the filters 200 within the filter frame 115. The securing magnets may also provide sufficient compression to the sealing flange 250 to provide a substantially airtight seal between the filter 200 and the sealing face 225, as described.

In an embodiment of the present invention, the filter cell 215 may be formed of: a ferrous material; a nonferrous material; or a polymeric material having, paramagnetic or diamagnetic properties, which may be magnetized. In an alternate embodiment of the present invention, an outer surface of the filter cell 215 which may interact or engage the filter frame 115 may be formed of: a ferrous material; a nonferrous material; or a polymeric material having, paramagnetic or diamagnetic properties, which may be magnetized.

In an embodiment of the present invention, the filter frame 115 may be formed of: a ferrous material; a nonferrous material; or a polymeric material having, paramagnetic or diamagnetic properties, which may be magnetized. In an alternate embodiment of the present invention, the shape of the filter frame 115 may include square, rectangular, or any other shape that allows the filter cell 215 to securely attach via the securing magnet 260.

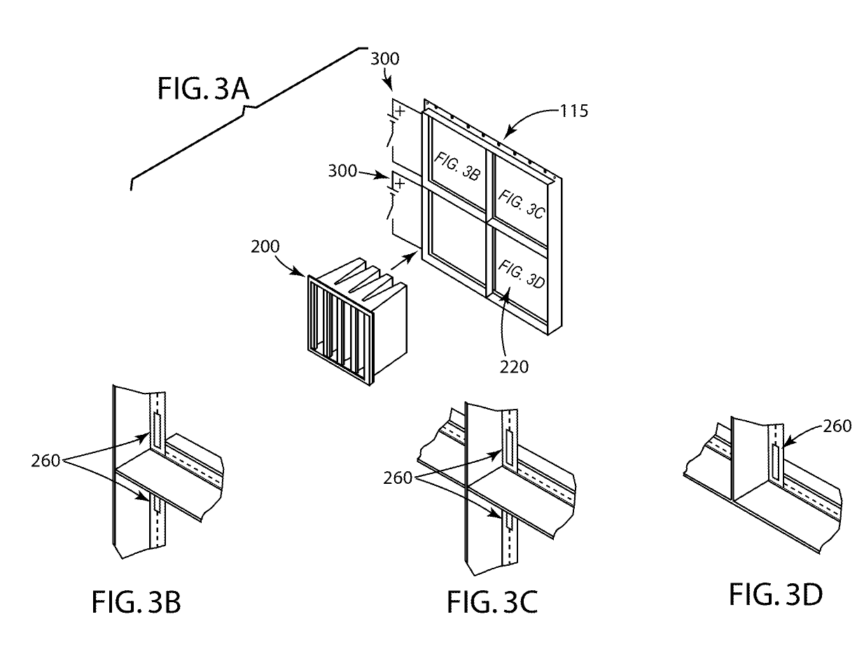

As illustrated in FIG. 3, the filter frame 115 may also comprise an electrical circuit 300 that energizes the securing magnet 260. This feature may allow for a quick connection or disconnection of the filter cell 215 to the filter frame 115.

In an embodiment of the present invention the securing magnet 260 may comprise one of the following types: a permanent magnet; an AC electromagnet; or a DC electromagnet. In an alternate embodiment of the present invention the filter frame 115 may comprise a plurality of securing magnets 260. Here, each corner of the filter frame 115 may be integrated with one of the plurality of securing magnets 260; as illustrated in FIG. 3.

FIGS. 3A-3D, collectively FIG. 3, is a schematic illustrating isometric and detail views of an embodiment of the filter frame 115. FIG. 3A illustrates a possible arrangement of the electrical circuits 300. Embodiments of the present invention may use other arrangements. This may include additional or fewer circuits 300. This may also include other types of circuits 300, which may be more or less electrically complex.

FIGS. 3B-3D illustrate detail views of portions of the aperture 220 in FIG. 3A. These detail views illustrate example locations for the securing magnets 260. FIGS. 3B and 3C have securing magnets 260 located in the upper and lower corners of the associated apertures 220. FIG. 3D illustrates a securing magnet 260 located in only the lower corner of the associated aperture 220. This is due to the structure of this portion of the filter frame 115.

In use, the filter cell 215 may be inserted through the aperture 220 of the filter frame 115. Then, the securing magnets 260 may secure the filter cell 215 in place. Depending on the type and operational nature of the securing magnets 260, the electrical circuit 300 may be used. Here, an operator may have the convenience of merely toggling a physical, or a soft switch, to energize the circuit 300. This action may secure the filter cell 215 to the filter frame 115.

The apparatus described herein provides several advantages. For example, the securing magnets 260 are small, simple, easy to fabricate, and inexpensive. Additionally, unlike known filter retention devices, the apparatus herein does not include any loose or easily detachable parts, thereby reducing the risk that a part may be lost. Furthermore, the clamping pressure applied to the filter gasket may be reliable and repeatable and does not depend on the skill of the installer, because the force applied by the latch depends on the dimensions of the magnet itself. Moreover, the apparatus described herein is faster and simpler to operate than known filter retention devices such as those that use bolted connections. The faster, simpler operation of the apparatus makes the overall filter removal and installation process much faster, particularly when repeated for the dozens or even hundreds of filters 200 in an inlet filter house 110.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

As one of ordinary skill in the art will appreciate, the many varying features and configurations described above in relation to the several embodiments may be further selectively applied to form other possible embodiments of the present invention. Those in the art will further understand that all possible iterations of the present invention are not provided or discussed in detail, even though all combinations and possible embodiments embraced by the several claims below or otherwise are intended to be part of the instant application. In addition, from the above description of several embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. An apparatus for securing a filter to an inlet system component, the apparatus comprising:
a filter cell comprising structure that houses a filter therein; wherein the filter cell substantially restrains movement of the filter; and
a filter frame comprising a aperture of a size that allows the filter cell to reside therein, wherein the filter frame comprises a securing magnet or a magnetic clamping mechanism which secures the filter cell to the filter frame.

2. The apparatus of claim 1, wherein an outer surface of the filter cell is formed of a material with at least one of the following properties: ferrous, nonferrous, polymeric or any material comprising paramagnetic or diamagnetic properties; wherein the material is structurally strong enough to secure the filter.

3. The apparatus of claim 1, wherein the filter frame comprises multiple apertures and each aperture secures at least one filter cell.

4. The apparatus of claim 1, wherein each aperture comprises a dedicated securing magnet or a magnetic clamping mechanism.

5. The apparatus of claim 1 further comprising at least one circuit positioned within the filter frame.

6. The apparatus of claim 5 wherein the circuit energizes the securing magnet, assisting with securing the filter cell to filter frame.

7. The apparatus of claim 1, wherein the securing magnet comprises one of the following types: a permanent magnet; an AC electromagnet; or a DC electromagnet.

8. The apparatus of claim 1, wherein the filter frame is positioned near a weather hood of an inlet system.

9. The apparatus of claim 8, wherein a surface of the filter frame is formed out of at least one of the following materials: a ferrous material; a nonferrous material; or a polymeric material comprising paramagnetic or diamagnetic properties.

10. The apparatus of claim 1, wherein the shape of the filter frame comprises: square, round, rectangular, or combinations thereof; and further comprises a plurality of securing magnets or magnetic clamping mechanisms, wherein an area adjacent each corner of the filter frame is integrated with one of the plurality of securing magnets or the magnetic clamping mechanisms.

11. A system for securing a filter to an inlet system component, the system comprising:
a turbomachine comprising a compressor and a turbine section;
an inlet system connected to the turbomachine upstream of the compressor; wherein the inlet system comprises: a weather hood; an inlet filter house; a transition piece; an inlet duct; and an inlet plenum;
a filter cell comprising structure that houses a filter therein; wherein the filter cell substantially restrains movement of the filter; and
a filter frame comprising a aperture of a size that allows the filter cell to reside therein, wherein the filter frame comprises a securing magnet which secures the filter cell to the filter frame.

12. The apparatus of claim 11, wherein an outer surface of the filter cell is formed of a material with at least one of the following properties: ferrous, nonferrous, polymeric or any material comprising paramagnetic or diamagnetic properties; wherein the material is structurally strong enough to secure the filter.

13. The system of claim 11, wherein the filter frame comprises multiple apertures and each aperture secures at least one filter cell.

14. The system of claim 11, wherein each aperture comprises a dedicated securing magnet or a magnetic clamping mechanism.

15. The system of claim 11 further comprising at least one circuit positioned within the filter frame.

16. The system of claim 15 wherein the circuit energizes the securing magnet, assisting with securing the filter cell to filter frame.

17. The system of claim 11, wherein the securing magnet comprises one of the following types: a permanent magnet; an AC electromagnet; or a DC electromagnet.

18. The system of claim 11, wherein the filter frame is positioned near the weather hood of the inlet system.

19. The system of claim 18, wherein a surface of the filter frame is formed out of at least one of the following materials: a ferrous material; a nonferrous material; or a polymeric material comprising paramagnetic or diamagnetic properties.

20. The apparatus of claim 11, wherein the shape of the filter frame comprises: square, round, rectangular, or combinations thereof; and further comprises a plurality of securing magnets or magnetic clamping mechanisms, wherein an area adjacent each corner of the filter frame is integrated with one of the plurality of securing magnets or the magnetic clamping mechanisms.
